(19) United States
(12) Patent Application Publication
(10) Pub. No.: US 2010/0003019 A1
(43) Pub. Date: Jan. 7, 2010

(54) Humidifier Unit

(76) Inventor: Robert John Watts, East Sussex (GB)

Correspondence Address: CLARK & BRODY, 1090 VERMONT AVENUE, NW, SUITE 250, WASHINGTON, DC, 20005, US

(21) Appl. No.: 12/084,115

(22) PCT Filed: Feb. 26, 2007
(86) PCT No.: PCT/GB2007/000662

§ 371 Date: May 8, 2009

(30) Foreign Application Priority Data
Feb. 28, 2006 (GB) 0603969.7

(51) Int. Cl. F24F 6/18; B23P 11/00

(52) U.S. Cl. 392/402; 29/428

(57) ABSTRACT

A humidifier unit (10) for injecting steam into air-conditioning ducting comprising at least one tubular portion (12) formed with at least one aperture (16) to enable steam to pass from the interior of the tubular portion (12) to the exterior thereof. The aperture (16) is formed through a wall portion (20) of the tubular portion to create an inwardly directed annular protuberance (18), which is integral with the surrounding wall portion (20). The protuberance (18) thus comprises the same material as the surrounding wall portion (20). Also a method of making such a humidifier unit (10) using thermal drilling or punching to create the aperture (16) and the annular protuberance (18).

The present invention relates to a humidifier unit, especially but not exclusively for injecting steam into air-conditioning ducting, to humidify the air provided by the air-conditioning.

A steam outlet assembly comprising a tubular portion, within which steam passes when the assembly is in use, and provided with steam release nozzles is known from document EP 0 823 597. Such a steam outlet assembly is used in atmospheric steam distribution to achieve short absorbance or entrainment distances within ventilation ductwork or within air handling units. This outlet assembly comprises a tubular portion through which steam is fed when the assembly is in use, and a plastics or metal nozzle which extends through apertures in the tubular portion, which are spaced apart circumferentially therearound, wherein the nozzle is provided with an opening in the tubular portion interior which is in communication with at least one outlet of the nozzle outside the tubular portion, and which nozzle is provided with seal means around the apertures on the outside of the tubular portion.

A disadvantage with this construction is that inserting the seals after the apertures have been formed is time consuming and costly. Furthermore, over time the seals may degrade and fail and will thus need replacing.

A further disadvantage with this construction is that the apertures for accepting the nozzles are preferably formed diametrically opposite one another in order that the seal means fit securely.

The present invention seeks to obviate one or more of these disadvantages.

Accordingly, the present invention is directed to a humidifier unit comprising at least one tubular portion formed with at least one aperture to enable steam to pass from the interior of the tubular portion to the exterior thereof, wherein the aperture is formed through a wall portion of the tubular portion to create an inwardly directed annular protuberance which is integral with the surrounding wall portion, the protuberance thus comprising the same material as the surrounding wall portion.

The annular protuberance may be formed by means of a punch, if the material of the tubular portion is sufficiently malleable such as copper. Preferably, however, the annular protuberance is formed by thermal drilling.

Thermal drilling is a drilling process in which the frictional heat developed is sufficient to make the material being drilled malleable. By using thermal drilling a hole and bush may be formed in one action by drilling through, for example, sheet material. A drill bit made of high strength tungsten carbide may be used. The bit usually has a cylindrical upper section and a lower conical or tapered forming part. The drill bit may be fitted to a standard drilling machine, and rotated at a relatively high rotational speed, between 1000 and 3500 rpm, and brought into contact with the subject material using relatively high axial pressure. The combined rotational and axial forces create frictional heat between the material and the drill bit forming part. The frictional heat can reach temperatures of 900° C. for the drill bit and 700° C. for the material. Such temperatures soften the material in the local area and make it sufficiently malleable to displace material of the sheet. As the pressure and rotation are maintained the heated material forms a bushing on the underside of the material. The shape, diameter and length of the bushing may be dictated by the shape of the drill bit and the depth and speed of the drilling. A lubricant is usually used during the process to prevent the material and drill bit welding together.

Advantageously, the annular protuberance protrudes from the wall portion of the tubular portion by between a quarter and two and a quarter times the radius of the aperture. Preferably, the annular protuberance protrudes by between half and one and a half times the radius of the aperture.

The or each aperture can be drilled and the or each protuberance can be formed in a single action. Therefore, there is no need to attach nozzles later on. This reduces manufacture time and costs. Furthermore, there are no further parts that may degrade over time, become damaged or require servicing.

Such a unit facilitates the rapid entrainment of steam for humidification. Furthermore, the steam which passes out through the aperture is from streams spaced from the inner surface of the tubular portion, which streams are therefore less cooled by that inner surface, and are therefore less likely to contain droplets that would increase the entrainment distance. Also, any drops of condensation formed at the aperture will drop from the protuberance, away from the inside surface of the tubular portion.

It is not essential for there to be pairs of apertures, with each one of the pair opposite the other, as the apertures do not need to be provided with any further parts.

Preferably, a plurality of apertures with associated annular protuberances are spaced apart along the tubular portion. Any condensation that does trickle down the inside wall of the tubular portion will be inhibited from spluttering through a lower aperture by virtue of the associated protuberance.

Advantageously, the humidifier unit comprises a plurality of tubular portions. The number of tubular portions and the number of apertures per tubular portion are dependent upon the desired duty and entrainment. Typically, the unit may entrain 10 kg per hour to 1000 kg per hour of steam over 900 cm² to 16 m².

Advantageously, respective intended lower ends of the tubular portions extend from and are in communication with a common feed pipe.

Preferably, the feed pipe is provided with a drip tray.

Preferably, a strip secures together the intended upper ends of the tubular portions.

Advantageously, the humidifier unit is provided with two or more feed pipes.

Preferably, a first set of tubular portions are fed by one feed pipe and a second set of tubular portions are fed by a second feed pipe.

Advantageously, the feed pipes are parallel and adjacent to one another, and the sets of tubular portions are spaced from one another longitudinally of the feed pipes.

Advantageously, the or each tubular portion comprises stainless steel, preferably grade 316 stainless steel, or copper.

Preferably, when the unit is in use in an air conditioning duct the apertures face the oncoming airflow.

The present invention extends to a method for making a humidifier unit.

An example of a humidifier unit made in accordance with the present invention is illustrated in the accompanying drawings, in which;

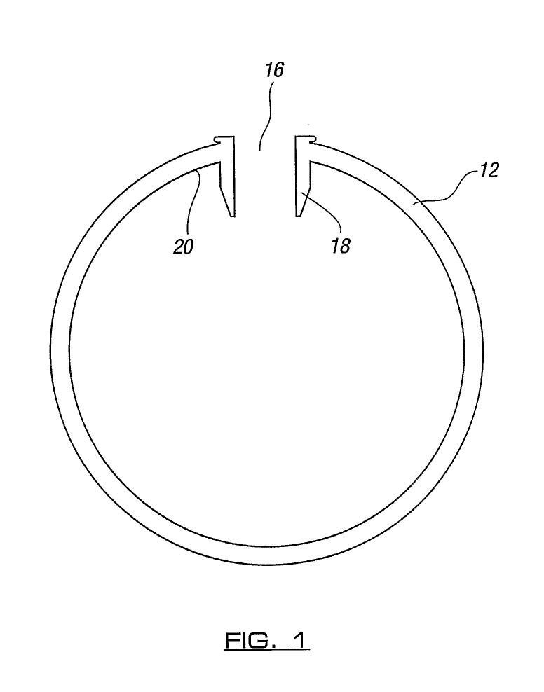

FIG. 1 shows a cross section through a part of a humidifier unit embodying the present invention;

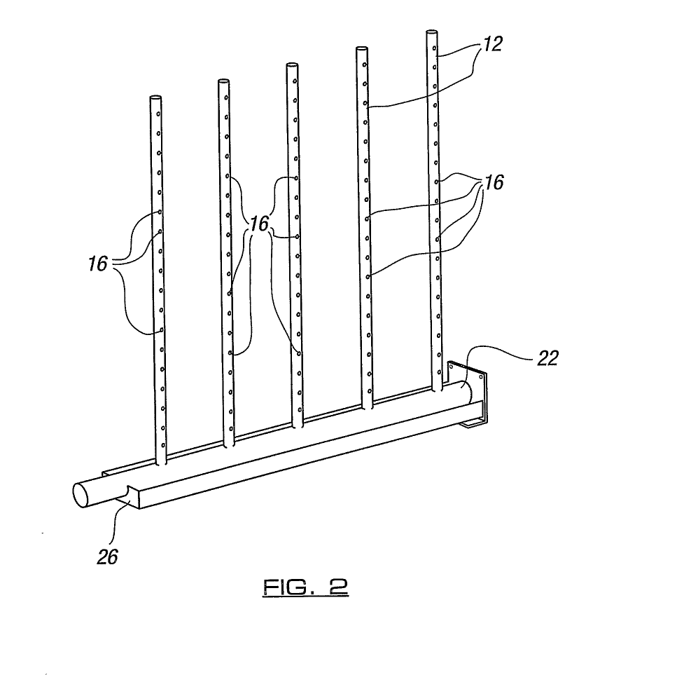

FIG. 2 shows a perspective view of parts of the humidifier unit embodying the present invention; and

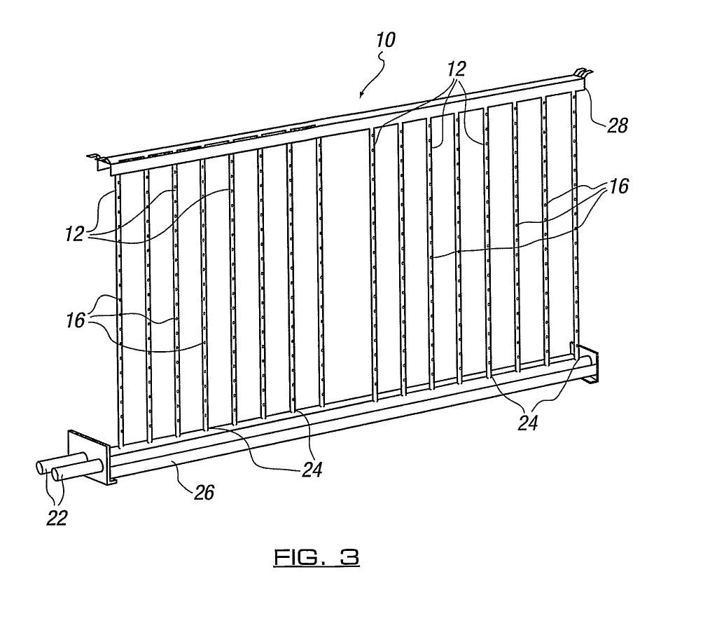

FIG. 3 shows a perspective view of the humidifier unit embodying the present invention.

The humidifier unit 10 shown in FIGS. 1 to 3 is an assembly comprising a plurality of stainless steel generally upright tubular portions 12, each tubular portion having a wall thickness of about 0.8 mm, although one of many other possible thicknesses is one of about 1.0 mm. Each tubular portion 12 is formed with apertures 16. The tubular portions have a diameter of about 15 mm, although one of many other possible diameters is one of about 22 mm. The apertures have a diameter of 6 mm, although other possible diameters are 3 mm, and 8 mm, for example. Each of the said apertures 16 has an inwardly directed annular protuberance 18 surrounding it and extending from the inside of wall portion 20 of the tubular portion 12. The annular protuberances 18 are created when the aperture 16 is thermally drilled through the wall portion 20 by means of an appropriate thermal drilling bit, so that the annular protuberance is integral with the surrounding wall portion 20, and comprises the same material as the surrounding wall portion 20. The protuberances protrude by about 2 mm, although one of many other possible protrusion lengths is one of about 3.5 mm.

Each of the tubular portions 12 is partially inserted into receiving apertures 24, formed in one of two parallel common feed pipes 22 also by thermal drilling, so that the interiors of the tubular portions 12 are in communication with the interior of one of the common feed pipes 22. The tubular portions 12 are inserted so as to be parallel with one another and at an angle of about one degree from normality with the feed pipes 22. The feed pipes 22 are mounted on and bolted to a drip tray 26 and a strip 28 secures the ends of the tubular portions 12 which are further from the feed pipes 22.

One set of tubular portions 12 is connected to one of the feed pipes 22, and another set to the other feed pipe 22, the two sets being spaced apart from one another longitudinally of the pipes 22.

When the assembly is in use, the feed pipes 22 are arranged to be horizontal with the tubular portions extending upwardly therefrom at an angle of 1° to the vertical. Whilst this is preferable, it is not to be presumed that this angle to the vertical has to be precise, and useful results could be obtained with this angle lying somewhere in the range from 0° to 5°, for example. Steam is fed to and flows through the interior of the feed pipes 22 and from these passes into the tubular portions 12. The steam then flows along the interiors of the tubular portions 12. Some of the steam will pass by any given one of the annular protuberances 18. However, some of the steam, because of the pressure differential between the interior of the tubular portion 12 and the exterior thereof, passes into an annular protuberance 18 and out of the associated aperture 16.

This illustrated humidifier unit enables the steam to be distributed into a ventilation duct system where a lamina steam distribution is required.

Numerous variations and modifications can be made to the illustrated humidifier unit without taking it outside the scope of the present invention. For example, the apertures of each tubular portion may be located at successive positions along a spiral around the tubular portion, rather than all opening at positions along a straight line on one side of the tubular portion. Whilst such a spiral arrangement is less desirable from the point of view of entrainment, it does reduce even further the likelihood of condensation from around a higher aperture being spluttered through a lower one.

1. A humidifier unit (10) comprising at least one tubular portion (12) formed with at least one aperture (16) to enable steam to pass from the interior of the tubular portion (12) to the exterior thereof, characterised in that the aperture (16) is formed through a wall portion (20) of the tubular portion (12) to create an inwardly directed annular protuberance (18) which is integral with the surrounding wall portion (20), the protuberance (18) thus comprising the same material as the surrounding wall portion (20).

2. A humidifier unit (10) according to claim 1, characterised in that the annular protuberance (18) is formed by thermal drilling.

3. A humidifier unit (10) according to claim 1, characterised in that the annular protuberance (18) protrudes from the wall portion (20) of the tubular portion (12) by between a quarter and two and a quarter times the radius of the aperture (16).

4. A humidifier unit (10) according to claim 3, characterised in that the annular protuberance (18) protrudes by between half and one and a half times the radius of the aperture (16).

5. A humidifier unit (10) according to claim 1, characterised in that the, or each, aperture (16) is drilled and the, or each, protuberance (18) is formed in a single action.

6. A humidifier unit (10) according to claim 1, characterised in that a plurality of apertures (16) with associated annular protuberances (18) are spaced apart along the tubular portion (12).

7. A humidifier unit (10) according to claim 1, characterised in that the humidifier unit (10) comprises a plurality of tubular portions (12).

8. A humidifier unit (10) according to claim 7, characterised in that the tubular portions (12) are substantially parallel to one another.

9. A humidifier unit (10) according to claim 7, characterised in that respective intended lower ends of the tubular portions (12) extend from and are in communication with a common feed pipe (22).

10. A humidifier unit (10) according to claim 9, characterised in that the feed pipe (22) is provided with a drip tray (26).

11. A humidifier unit (10) according to claim 8, characterised in that a strip (28) secures together the intended upper ends of the tubular portions (12).

12. A humidifier unit (10) according to claim 7, characterised in that the humidifier unit (10) is provided with two or more feed pipes (22).

13. A humidifier unit (10) according to claim 12, characterised in that a first set of tubular portions (12) are fed by one feed pipe (22) and a second set of tubular portions (12) are fed by a second feed pipe (22).

14. A humidifier unit (10) according to claim 12, characterised in that the sets of tubular portions (12) are spaced from one another longitudinally of the feed pipes (22).

15. A humidifier unit (10) according to claim 1, characterised in that the, or each, tubular portion (12) comprises stainless steel,

16. A humidifier unit (10) according to claim 15, characterised in that the, or each, tubular portion (12) comprises grade 316 stainless steel.

17. A humidifier unit (10) according to claim 1, characterised in that the, or each, tubular portion (12) comprises copper.

18. A humidifier unit (10) according to claim 1, characterised in that when the unit (10) is in use in an air conditioning duct the, or each, aperture (16) faces the oncoming airflow.

19. A humidifier unit (10) according to claim 3, characterised in that the annular protuberance (18) is formed by means of a punch.

20. A method of making a humidifier unit (10) comprising creating an aperture (16) through a wall portion (20) of a tubular portion (12) to create an inwardly directed annular protuberance (18) which is integral with the surrounding wall portion (20), the protuberance (18) thus comprising the same material as the surrounding wall portions (20).

21. A method of making a humidifier unit (10) according to claim 20, characterised in that the aperture (16) is created by thermal drilling.

22. A method of making a humidifier unit (10) according to claim 21, characterised in that the humidifier unit (10) comprises a humidifier unit (10) comprising at least one tubular portion (12) formed with at least one aperture (16) to enable steam to pass from the interior of the tubular portion (12) to the exterior thereof, the aperture (16) is formed through a wall portion (20) of the tubular portion (12) to create an inwardly directed annular protuberance (18) which is integral with the surrounding wall portion (20), the protuberance (18) thus comprising the same material as the surrounding wall portion (20), in that the annular protuberance (18) is formed by thermal drilling, and in that the annular protuberance (18) protrudes from the wall portion (20) of the tubular portion (12) by between a quarter and two and a quarter times the radius of the aperture (16).

23. A method of making a humidifier unit (10) according to claim 20, characterised in that the aperture (16) is created by punching.

24. A method of making a humidifier unit (10) according to claim 23, characterised in that the humidifier unit (10) comprises at least one tubular portion (12) formed with at least one aperture (16) to enable steam to pass from the interior of the tubular portion (12) to the exterior thereof, in that the aperture (16) is formed through a wall portion (20) of the tubular portion (12) to create an inwardly directed annular protuberance (18) which is integral with the surrounding wall portion (20), the protuberance (18) thus comprising the same material as the surrounding wall portion (20), in that the annular protuberance (18) is formed by thermal drilling, and in that the annular protuberance (18) protrudes from the wall portion (20) of the tubular portion (12) by between a quarter and two and a quarter times the radius of the aperture (16) and in that the annular protuberance (18) is formed by means of a punch.
